(19) United States
(12) Patent Application Publication
(10) Pub. No.: US 2025/0232772 A1
(43) Pub. Date: Jul. 17, 2025

(54) VISUAL SPEECH RECOGNITION BASED ON LIP MOVEMENTS USING GENERATIVE ARTIFICIAL INTELLIGENCE (AI) MODEL

(71) Applicant: SONY GROUP CORPORATION, TOKYO (JP)

(72) Inventors: JONG HWA LEE, SAN DIEGO, CA (US); FRANCISCO COSTELA, SAN DIEGO, CA (US); PAUL WISECAVER, SAN DIEGO, CA (US)

(21) Appl. No.: 18/808,370

(22) Filed: Aug. 19, 2024

Related U.S. Application Data
(60) Provisional application No. 63/619,871, filed on Jan. 11, 2024.

(51) Int. Cl. G10L 15/25; G10L 15/00; G10L 15/02; G10L 15/183

(52) U.S. Cl. CPC G10L 15/25; G10L 15/005; G10L 15/02; G10L 15/183

(57) ABSTRACT

An electronic device and a method for implementation for visual speech recognition based on lip movements. The electronic device receives a set of images including one or more human speaker and applies a first machine learning (ML) model on the received set of images. The electronic device determines a first set of words spoken by the one or more human speakers based on the application of the first ML model. The determined first set of words corresponds to lip movements of the one or more human speakers. The electronic device applies a first generative Artificial Intelligence (AI) model on the determined first set of words. The electronic device predicts a first sentence corresponding to the determined first set of words spoken by the one or more human speakers, based on the application of the first generative AI model.

### CROSS-REFERENCE TO RELATED APPLICATIONS/INCORPORATION BY REFERENCE

This Application also makes reference to U.S. Provisional Application Ser. No. 63/619,871 which was filed on Jan. 11, 2024. The above stated Patent Application is hereby incorporated herein by reference in its entirety.

### FIELD

Various embodiments of the disclosure relate to speech recognition. More specifically, various embodiments of the disclosure relate to an electronic device and a method for visual speech recognition based on lip movements.

### BACKGROUND

Speech recognition is a technology that enables machines to interpret and understand human speech. Speech recognition has numerous applications, from voice assistants on smartphones to transcription services for businesses. While traditional speech recognition may primarily rely on audio input, visual speech recognition (VSR) takes a different approach based on visual cues of speech, for example, lip movements. VSR systems may analyze video footage of a speaker's face to determine what words are being spoken. For example, a VSR system may be used in a noisy environment like a factory floor, where a worker's speech may be recognized based on the worker's lip movements, even if the speech audio is unclear due to background noise. VSR technology may have potential applications in various fields, including assistive technologies for the hearing impaired and enhanced communication systems in challenging acoustic environments.

However, VSR faces several challenges that limit its effectiveness. One major issue may be a difficulty in accurate interpretation of complex speech patterns and sentence structures based solely on visual information. Additionally, VSR systems may often struggle with variations in lighting conditions, camera angles, and individual speech styles. The development of robust VSR systems may also requires large, diverse dataset of video recordings paired with accurate transcriptions, which can be time consuming and expensive to create.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for visual speech recognition based on lip movements using generative Artificial Intelligence (AI) model is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for visual speech recognition based on lip movements, in accordance with an embodiment of the disclosure.

FIG. 2 is a block diagram that illustrates an exemplary electronic device of FIG. 1, in accordance with an embodiment of the disclosure.

FIG. 3 is a diagram that illustrates an exemplary processing pipeline for generative AI based visual speech recognition, in accordance with an embodiment of the disclosure.

FIG. 4 is a diagram that illustrates a first exemplary processing pipeline for first sentence prediction, in accordance with an embodiment of the disclosure.

FIG. 5 is a diagram that illustrates a second exemplary processing pipeline for first sentence prediction, in accordance with an embodiment of the disclosure.

FIG. 6 is a diagram that illustrates an exemplary table including a set of words, in accordance with an embodiment of the disclosure.

FIG. 7 is a flowchart that illustrates operations of an exemplary method for visual speech recognition based on lip movements, in accordance with an embodiment of the disclosure.

### DETAILED DESCRIPTION

The following described implementation may be found in an electronic device and method for visual speech recognition based on lip movements. Exemplary aspects of the disclosure may provide an electronic device that may receive a set of images including one or more human speakers. Further, the electronic device may apply a first machine learning (ML) model on the received set of images. The electronic device may determine a first set of words spoken by the one or more human speakers based on the application of the first ML model. The determined first set of words may correspond to lip movements of the one or more human speakers. Thereafter, the electronic device may apply a first generative Artificial Intelligence (AI) model on the determined first set of words. Based on the application of the first generative AI model, the electronic device may predict a first sentence corresponding to the determined first set of words spoken by the one or more human speakers.

Traditional visual speech recognition (VSR) techniques may often struggle to accurately predict complete sentences, especially in case of unstructured or complex linguistic constructions. The traditional VSR techniques may typically rely on extensive labeled datasets for training, that may be costly to develop and limit their ability to generalize to unseen words or phrases. Additionally, traditional VSR techniques may often perform poorly in real-world scenarios with background noise, varying lighting conditions, or multiple speakers.

The disclosed electronic device may utilize a combination of machine learning and generative AI models to predict complete sentences from lip movements. The use of generative AI may allow the disclosed electronic device to fill in gaps and form complete words and sentences, may improve accuracy and versatility. The disclosed technique may be able to handle both structured and unstructured sentences in various languages, making it more adaptable to different linguistic contexts. Thus, the challenge of interpretation of complex speech patterns may be overcome. Furthermore, the disclosed electronic device may operate effectively with limited training data, and hence reduced development cost with better generalization. Thus, the issue of collation of a large, labelled dataset of videos and corresponding textual labels may be resolved.

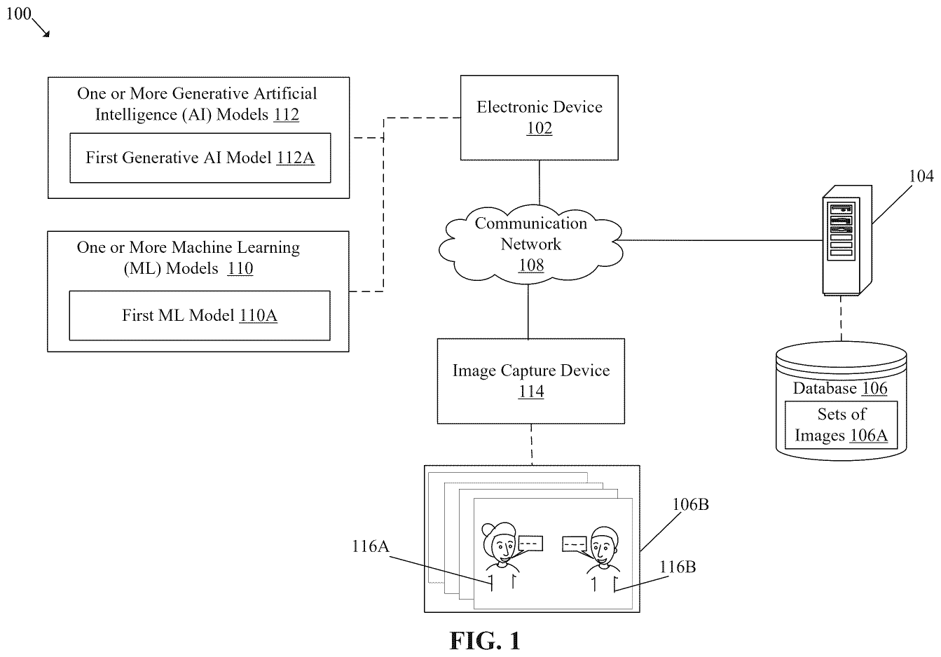

FIG. 1 is a block diagram that illustrates an exemplary network environment for visual speech recognition based on lip movements, in accordance with an embodiment of the disclosure. With reference to FIG. 1, there is shown a network environment 100. The network environment 100 may include an electronic device 102, a server 104, a database 106, and a communication network 108. The electronic device 102 may include one or more ML models 110 (including, for example, a first ML model 110A) and one or more generative AI models 112 (including, for example, a first generative AI model 112A). The database 106 may store a set of images 106A. The network environment 100 may further include an image capture device 114 (associated with the electronic device 102) that may be configured to capture a set of images 106B. In an embodiment, the set of images 106A stored on the database 106 may include the captured set of images 106B.

The electronic device 102 may include suitable logic, circuitry, interfaces, and/or code that may be configured to receive the set of images 106B including one or more human speakers, for instance, human speakers 116A and 116B. Further, the electronic device 102 may apply the first machine learning model 110A on the received set of images 106B. Further, the electronic device 102 may determine a first set of words spoken by the one or more human speakers 116A and 116B based on the application of the first ML model 110A. The determined first set of words may correspond to lip movements of the one or more human speakers 116A and 116B. Further, the electronic device 102 may apply the first generative AI model 112A on the determined first set of words. Further, the electronic device 102 may predict a first sentence corresponding to the determined first set of words spoken by the one or more human speakers 116A and 116B, based on the application of the first generative AI model 112A. Examples of the electronic device 102 may include, but are not limited to, a computing device, a smartphone, a cellular phone, a mobile phone, a gaming device, a mainframe machine, a server, a computer work-station, a machine learning (ML)-enabled device, and/or a consumer electronic (CE) device.

The server 104 may include suitable logic, circuitry, and interfaces, and/or code that may be configured to receive the set of images 106B including the one or more human speakers. The received set of images 106B may be stored in the database 106, as a part of the sets of images 106A. The server 104 may apply the first ML model 110A on the received set of images 106B. The server 104 may determine the first set of words spoken by the one or more human speakers 116A and 116B, based on the application of the first ML model 110A. The first set of words may correspond to lip movements of the one or more human speakers 116A and 116B. The server 104 may apply the first generative AI model 112A on the determined first set of words. Further, the server 104 may predict a first sentence corresponding to the determined first set of words spoken by the one or more human speakers 116A and 116B, based on the application of the first generative AI model 112A.

Though not shown in FIG. 1, in an embodiment, the server 104 may include first ML model 110A and the first generative AI model 112A. The server 104 may receive the set of images 106B from the database 106 and/or the electronic device 102. The server 104 may determine the first set of words spoken by the one or more human speakers 116A and 116B, based on the application of the first ML model 110A. The server 104 may apply the first generative AI model 112A on the determined first set of words. Further, the server 104 may predict a first sentence corresponding to the determined first set of words spoken by the one or more human speakers 116A and 116B, based on the application of the first generative AI model 112A. The server 104 may transmit the predicted first sentence to the electronic device 102.

The server 104 may be implemented as a cloud server and may execute operations through web applications, cloud applications, HTTP requests, repository operations, file transfer, and the like. Other example implementations of the server 104 may include, but are not limited to, a database server, a file server, a web server, a media server, an application server, a mainframe server, a machine learning server (enabled with or hosting, for example, a computing resource, a memory resource, and a networking resource), or a cloud computing server.

In at least one embodiment, the server 104 may be implemented as a plurality of distributed cloud based resources by use of several technologies that are well known to those ordinarily skilled in the art. A person with ordinary skill in the art will understand that the scope of the disclosure may not be limited to the implementation of the server 104 and the electronic device 102, as two separate entities. In certain embodiments, the functionalities of the server 104 can be incorporated in its entirety or at least partially in the electronic device 102 without a departure from the scope of the disclosure. In certain embodiments, the server 104 may host the database 106. Alternatively, the server 104 may be separate from the database 106 and may be communicatively coupled to the database 106.

The database 106 may include suitable logic, interfaces, and/or code that may be configured to store the set of images 106A that may include the set of images 106B (that may be captured by the image capture device 114). The database 106 may also store the predicted first sentence. The database 106 may be derived from data off a relational or non-relational database, or a set of comma-separated values (csv) files in conventional or big-data storage. The database 106 may be stored or cached on a device, such as a server (e.g., the server 104) or the electronic device 102. The device storing the database 106 may be configured to receive a query for a set of images from the electronic device 102 or the server 104. In response, the device of the database 106 may be configured to retrieve and provide the queried set of images from the images stored on the database 106 to the electronic device 102 or the server 104, based on the received query.

In some embodiments, the database 106 may be hosted on a plurality of servers stored at the same or different locations. The operations of the database 106 may be executed using hardware including a processor, a microprocessor (e.g., to perform or control performance of one or more operations), a field-programmable gate array (FPGA), or an application-specific integrated circuit (ASIC). In some other instances, the database 106 may be implemented using software.

The communication network 108 may include a communication medium through which the electronic device 102 and the server 104 may communicate with one another. The communication network 108 may be one of a wired connection or a wireless connection. Examples of the communication network 108 may include, but are not limited to, the Internet, a cloud network, Cellular or Wireless Mobile Network (such as Long-Term Evolution and 5th Generation (5G) New Radio (NR)), satellite communication system (using, for example, low earth orbit satellites), a Wireless Fidelity (Wi-Fi) network, a Personal Area Network (PAN), a Local Area Network (LAN), or a Metropolitan Area Network (MAN). Various devices in the network environment 100 may be configured to connect to the communication network 108 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

The first ML model 110A may be a classifier or a regression or a clustering machine learning model, which may be trained to identify a relationship between inputs, such as features in a training dataset (e.g., the set of images 106A) and output labels, such as words or sets of words. The first ML model 110A may be defined by its hyper-parameters, for example, number of weights, cost function, input size, number of layers, and the like. The parameters of the first ML model 110A may be tuned and weights may be updated so as to move towards a global minima of a cost function for the first ML model 110A. After several epochs of the training on the feature information in the training dataset, the first ML model 110A may be trained to output a prediction/classification result for a set of inputs, for instance sets of images 106A. The prediction result may be indicative of a class label for each input of the set of inputs (e.g., input features extracted from new/unseen instances).

The first ML model 110A may include electronic data, which may be implemented as, for example, a software component of an application executable on the electronic device 102. The first ML model 110A may rely on libraries, external scripts, or other logic/instructions for execution by a processing device, such as circuitry. The first ML model 110A may include code and routines configured to enable a computing device, such as the circuitry to perform one or more operations, such as determination of words or sets of words. Additionally or alternatively, the first ML model 110A may be implemented using hardware including a processor, a microprocessor (e.g., to perform or control performance of one or more operations), a field-programmable gate array (FPGA), or an application-specific integrated circuit (ASIC). Alternatively, in some embodiments, the first ML model 110A may be implemented using a combination of hardware and software.

The first generative AI model 112A may include a generator model and a discriminator model. The first generative AI model 112A may be trained based on embeddings of the sets of images 106A, and embeddings of corresponding words/sets of words. The discriminator model may be trained using embeddings associated with the sets of words, which may include both structured sentences and unstructured sentences. The training may be such that the discriminator model may classify whether an output, generated by the generator model, is associated with a structured sentence or an unstructured sentence. The generator model may be trained to generate an output for the received set of images 106B such that the discriminator model may accurately predict whether a sentence that is spoken by a human speaker. Thus, based on the training, the first generative AI model 112A may be configured to predict the first sentence corresponding to the determined first set of words spoken by the one or more human speakers 116A and 116B. Examples of the first generative AI model 112A may include, but are not limited to, a Generative Adversarial Network (GAN) model, a variational autoencoder (VAE) model, an auto-regressive model, a Generative Pre-trained Transformers (GPT) model, or a large language model (LLM).

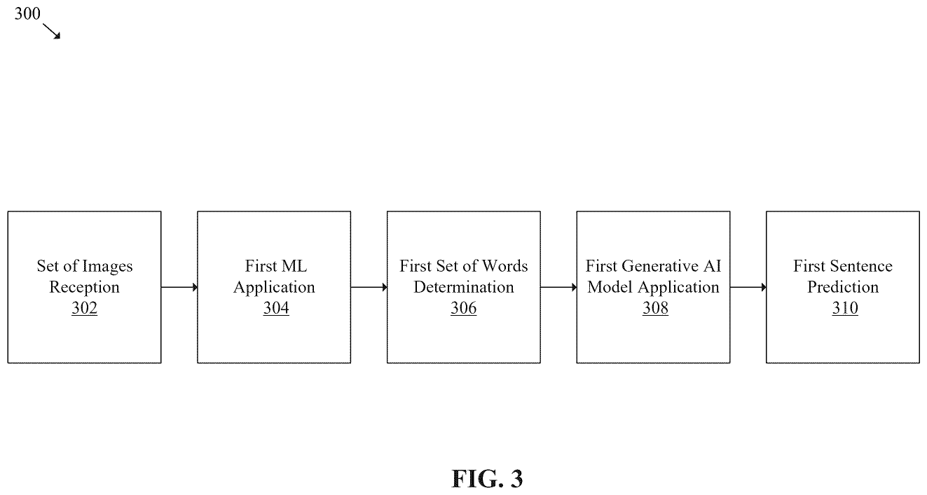

In operation, the electronic device 102 may be configured to receive the set of images 106B including one or more human speakers 116A and 116B. The set of images 106A stored on the database 106 may include the set of images 106B that may be captured by the image capture device 114. The electronic device 102 may receive the set of images 106B from the database 106 and/or the image capture device 114. Details related to the reception of set of images are further provided, for example, in FIG. 3 (at 302).

The electronic device 102 may apply the first ML model 110A on the received set of images 106B. The received set of images 106B may be converted into input vectors. The first ML model 110A may be applied on the input vectors to determine a first set of words associated with the one or more human speakers 116A and 116B in the set of images 106B. Details related to the application of the first ML model are further provided, for example, in FIG. 3 (at 304).

The electronic device 102 may determine a first set of words spoken by the one or more human speakers 116A and 116B, based on the application of the first ML model 110A on the received set of images. The determined first set of words may correspond to lip movements of the one or more human speakers 116A and 116B. Details related to the determination of the first set of words are further provided, for example, in FIG. 3 (at 306).

The electronic device 102 may apply the first generative AI model 112A on the determined first set of words. Based on the application of the first generative AI model 112A on the determined first set of words, a first sentence may be predicted. For example, the first generative AI model 112A may be a large language model or a natural language processing model that may determine words that may be used with the determined first set of words to form a meaningful sentence, such as, the first sentence. Details related to the application of the first generative AI model are further provided, for example, in FIG. 3 (at 308).

The electronic device 102 may predict a first sentence corresponding to the determined first set of words spoken by the one or more human speakers, based on the application of the first generative AI model 112A. The predicted first sentence corresponds to one of a structured sentence or an unstructured sentence, i.e., the electronic device 102 may predict a structured sentence as well as an unstructured sentence. In an embodiment, the electronic device 102 may initially concatenate the determined first set of words, and further the electronic device 102 may apply the first generative AI model 112A on the concatenated first set of words. Furthermore, the prediction of the first sentence may be based on the application of the first generative AI model 112A on the concatenated first set of words. In another embodiment, based on the application of the first generative AI model 112A, the electronic device 102 may generate a group of words associated with the determined first set of words. Further, the prediction of the first sentence corresponding to the determined first set of words may be based on the generated group of words. Moreover, the predicted first sentence may include one or more of the generated group of words and the determined first set of words. Details related to the prediction of the first sentence are further provided, for example, in FIG. 3 (at 310).

The electronic device 102 may also receive a set of audio frames associated with the received set of images. The electronic device 102 may receive the set of audio frames from the database 106 or from some external source. Further, the electronic device 102 may apply a third ML model (which may also form a part of the one or more ML models 110) on the received set of audio frames. The determination of the first set of words spoken by the one or more human speakers 116A and 116B may be based on the application of the third ML model.

The electronic device 102 may also detect a first human speaker (e.g., the speaker 116A) of the one or more human speakers, based on the received set of images. In an example, the electronic device 102 may use a facial recognition technique and/or a deep learning model to detect the first human speaker from the received set of images. In an embodiment, the determination of the first set of words may be further based on the detection of the first human speaker. In an example, the electronic device 102 may determine words that are spoken by a certain human speaker, based on the detection of the particular human speaker. Accordingly, the electronic device 102 may transcribe a conversation between the one or more human speakers 116A and 116B.

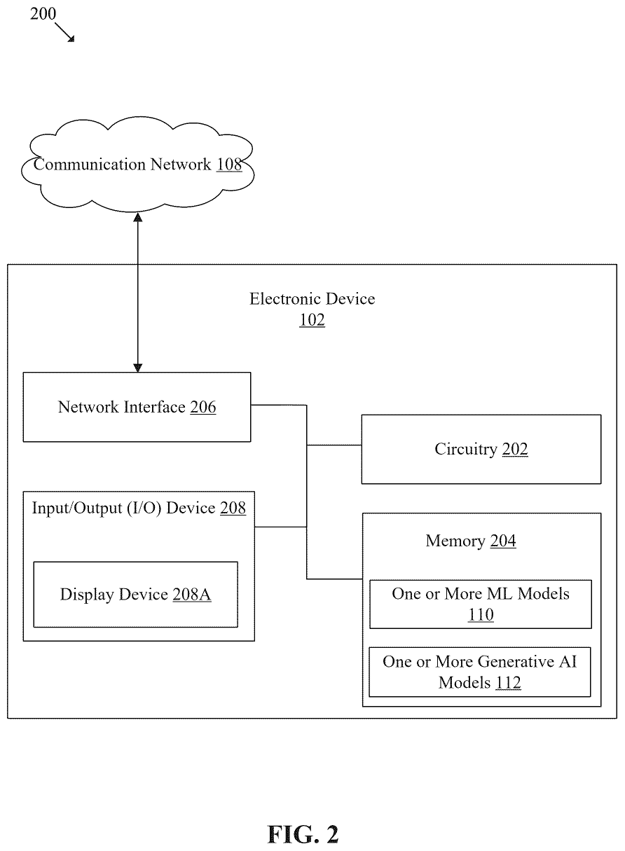

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown a block diagram 200 of the exemplary electronic device 102. The electronic device 102 may include circuitry 202, a memory 204, a network interface 206, and an input/output (I/O) device 208. The I/O device 208 may include a display device 208A. The memory 204 may include the one or more ML models 110 and the one or more generative AI models 112. The network interface 210 may connect the electronic device 102 with the server 104, via the communication network 108.

The circuitry 202 may include suitable logic, circuitry, and/or interfaces that may be configured to execute program instructions associated with different operations to be executed by the electronic device 102. The operations may include the reception of set of images, the application of the first ML model, the determination of the first set of words, an application of the generative AI model, and the first sentence prediction. The circuitry 202 may include one or more processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86Based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The one or more instructions stored in the memory 204 may be configured to execute the different operations of the circuitry 202 (and/or the electronic device 102). The memory 204 may be further configured to store the sets of images 106A including the set of images 106B. The memory 204 may also be configured to store the one or more ML models 110. The memory 204 may also be configured to store the one or more generative AI models 112. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 206 may include suitable logic, circuitry, interfaces, and/or code that may be configured to facilitate communication between the electronic device 102 and the server 104, via the communication network 108. The network interface 206 may be implemented by use of various known technologies to support wired or wireless communication of the electronic device 102 with the communication network 108. The network interface 206 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 206 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (WCDMA), Long Term Evolution (LTE), 5th Generation (5G) New Radio (NR), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VOIP), light fidelity (Li-Fi), Worldwide Interoperability for Microwave Access (Wi-MAX), a protocol for email, instant messaging, and a Short Message Service (SMS).

The I/O device 208 may include suitable logic, circuitry, interfaces, and/or code that may be configured to receive an input and provide an output based on the received input. For example, the I/O device 208 may receive the set of images 106B including one or more human speakers 116A and 116B from the image capture device 114. The I/O device 208 may be further configured to display or render the determined first set of words and the predicted first sentence. The I/O device 208 may include the display device 208A. Examples of the I/O device 208 may include, but are not limited to, a display (e.g., a touch screen), a keyboard, a mouse, a joystick, a microphone, or a speaker. Examples of the I/O device 208 may further include braille I/O devices, such as, braille keyboards and braille readers.

The display device 208A may include suitable logic, circuitry, and interfaces that may be configured to display or render the determined first set of words and the predicted first sentence. The display device 208A may be a touch screen which may enable a user (e.g., the user 116) to provide a user-input via the display device 208A. The touch screen may be at least one of a resistive touch screen, a capacitive touch screen, or a thermal touch screen. The display device 208A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the display device 208A may refer to a display screen of a head mounted device (HMD), a smart-glass device, a see-through display, a projection-based display, an electrochromic display, or a transparent display. Various operations of the circuitry 202 for implementation of generative AI based visual speech recognition are described further, for example, in FIG. 3.

FIG. 3 is a diagram that illustrates an exemplary processing pipeline for generative AI based visual speech recognition, in accordance with an embodiment of the disclosure. FIG. 3 is explained in conjunction with elements from FIG. 1 and FIG. 2. With reference to FIG. 3, there is shown an exemplary processing pipeline 300 that illustrates exemplary operations from 302 to 310 for implementation of generative AI based visual speech recognition. The exemplary operations 302 to 310 may be executed by any computing system, for example, by the electronic device 102 of FIG. 1 or by the circuitry 202 of FIG. 2.

At 302, an operation for reception of a set of images may be executed. The circuitry 202 may be configured to receive the set of images 106B including one or more human speakers 116A and 116B. For example, the image capture device 114 may capture the set of images 106B. The image capture device 114 may transmit the captured set of images 106B to the database 106 for storage. The set of images 106A stored on the database 106 may include the captured set of images 106B. The electronic device 102 may receive the set of images 106B from the database 106 and/or the image capture device 114. In an embodiment, the circuitry 202 may extract features of the one or more human speakers 116A and 116B from the received set of images 106B, such as lip movements. For example, the circuitry 202 may apply image processing techniques, such as, object detection and edge detection, to extract the features.

At 304, an operation for application of a first ML model may be executed. The circuitry 202 may be configured to apply the first ML model 110A on the received set of images 106B. In an instance, the first ML model 110A may be a neural network model with 1024 neurons. For example, the neural network model may correspond to a convolution neural network model. In an embodiment, the electronic device 102 may feed intensity values of pixels of each image of the set of images 106B to the first ML model 110A. The intensity values of pixels may be converted in input vectors for the first ML model 110A. The conversion of intensity values of the pixels into the input vectors may typically involve a representation of each pixel's intensity value as a numerical value and an organization of the intensity values of pixels into a vector format. This can be achieved by assigning a numerical value to each intensity level, such as mapping grayscale values from 0 to 255. Each pixel's intensity value may then be assigned to a corresponding position in the input vector. The resulting input vectors can be used as input data for machine learning or image processing algorithms associated with the first ML model 110A. In an embodiment, the input vectors may correspond to the features extracted from the set of images 106B. The first ML model 110A may be applied on the input vectors to determine a first set of words associated with the one or more human speakers 116A and 116B in the set of images 106B.

At 306, an operation for determination of a first set of words spoken by the one or more human speakers may be executed. The circuitry 202 may be configured to determine the first set of words spoken by the one or more human speakers 116A and 116B based on the application of the first ML model 110A. In an instance, the first set of words may be determined by the first ML model 110A based on the input vectors corresponding to the features extracted from the set of images 106B. The determined first set of words may correspond to lip movements of the one or more human speakers 116A and 116B. In an example, the electronic device 102 may detect a first human speaker (e.g., the human speaker 116A) as a person who may be a current speaker in conversation with another speaker (e.g., the human speaker 116B), based on the received set of images 106B. The determination of the first set of words may be further based on the detection that the first human speaker (e.g., the human speaker 116A) is the current speaker. Accordingly, the circuitry 202 may determine lip movements of the first human speaker (e.g., the human speaker 116A). In an example, the lip movements may be tracked across images in the set of images 106B based on image processing techniques, such as, object detection and edge detection. Information related to the tracked lip movements may be converted into features or input vectors to be fed to the first ML model 110A, such as, a neural network model (e.g., a convolution neural network model). Based on the features/input vectors fed to the first ML model 110A, the first ML model 110A may determine words/set of words spoken by the first human speaker (e.g., the human speaker 116A).

At 308, an operation for application of a first generative AI model may be executed. The circuitry 202 may be configured to apply the first generative AI model 112A on the determined first set of words. For example, the first generative AI model 112A may be a large language model or a natural language processing model that may determine words that may be used with the determined first set of words to form a meaningful sentence, such as, the first sentence. In an embodiment, the circuitry 202 may concatenate the determined first set of words, and further apply the first generative AI model 112A on the concatenated first set of words. The first generative AI model 112A may break the determined first set of words into multiple tokens, where each of the multiple tokens may be represented as a high-dimensional vector in an embedding space. Embeddings corresponding to each of the multiple tokens may capture semantic relationships between the first set of words, which may allow the first generative AI model 112A to determine a context of the each of the multiple tokens.

At 310, an operation for prediction of a first sentence may be executed. The circuitry 202 may be configured to predict a first sentence corresponding to the determined first set of words spoken by the one or more human speakers 116A and 116B, based on the application of the first generative AI model 112A. The predicted first sentence may correspond to one of a structured sentence or an unstructured sentence. The first generative AI model 112A may process each of the multiple tokens sequentially, and thereby determine the context of each of the multiple tokens based on preceding tokens. Further, the first generative AI model 112A may generate a group of words associated with the preceding tokens based on a prediction of succeeding tokens. The generated group of words may be associated with the determined first set of words. Further, the prediction of the first sentence may be based on the determined first set of words and the generated group of words. In an instance, the determined first set of words may be “I here London”, then the circuitry 202 may predict the first sentence as a structured sentence “I am here in London.” based on the application of the first generative AI model 112A. In an instance, the determined first set of words may be “music stop”, then the circuitry 202 may predict the first sentence as an unstructured sentence “music stop” based on the application of the first generative AI model 112A.

Traditional visual speech recognition (VSR) techniques may often struggle to accurately predict complete sentences, especially in case of unstructured or complex linguistic constructions. The traditional VSR techniques may typically rely on extensive labeled datasets for training, that may be costly to develop and limit their ability to generalize to unseen words or phrases. Additionally, traditional VSR techniques may often perform poorly in real-world scenarios with background noise, varying lighting conditions, or multiple speakers.

The disclosed electronic device 102 may utilize a combination of machine learning model (e.g., the first ML model 110A) and generative AI model (e.g., the first generative AI model 112A) to predict complete sentences from lip movements. The use of generative AI may allow the disclosed electronic device 102 to fill in gaps and form complete words and sentences, may improve accuracy and versatility. The disclosed technique may be able to handle both structured and unstructured sentences in various languages, making it more adaptable to different linguistic contexts. Thus, the challenge of interpretation of complex speech patterns may be overcome. Furthermore, the disclosed electronic device 102 may operate effectively with limited training data, and hence reduced development cost with better generalization. Thus, the issue of collation of a large, labelled dataset of videos and corresponding textual labels may be resolved.

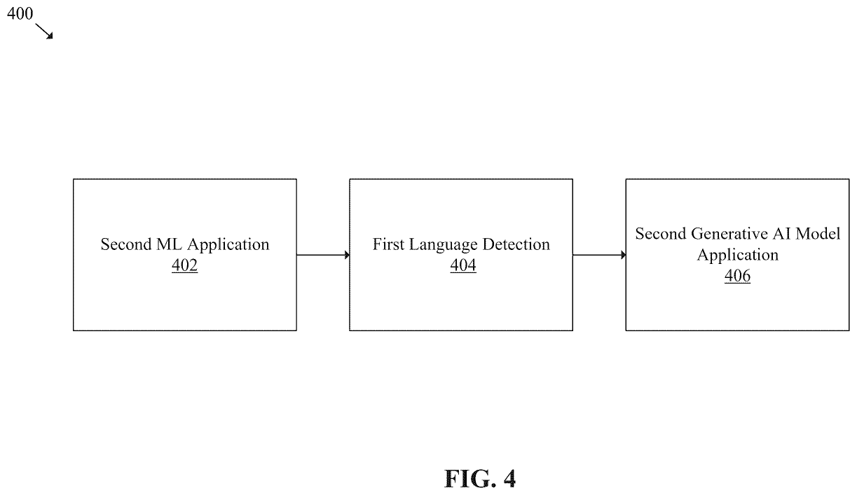

FIG. 4 is a diagram that illustrates a first exemplary processing pipeline for first sentence prediction, in accordance with an embodiment of the disclosure. FIG. 4 is described in conjunction with elements from FIG. 1, FIG. 2, and FIG. 3. With reference to FIG. 4, there is shown an exemplary first processing pipeline 400 that illustrates exemplary operations from 402 to 406 for implementation of generative AI based visual speech recognition. The exemplary operations 402 to 406 may be executed by any computing system, for example, by the electronic device 102 of FIG. 1 or by the circuitry 202 of FIG. 2.

At 402, an operation for a second ML model application may be executed. The circuitry 202 may be configured to apply a second ML model on the determined first set of words spoken by the one or more human speakers 116A and 116B. The second ML model may be included in the one or more ML models 110. The second ML model may represent the determined first set of words as vectors, through a word embedding process. The second ML model may efficiently determine a context associated with the determined first set of words, based on a distance metric between vectors of the determined first set of words.

At 404, an operation for a first language detection may be executed. The circuitry 202 may be configured to detect a first language associated with the determined first set of words based on the application of the second ML model. In an embodiment, the second ML model may be trained to detect words in multiple languages. The second ML model may detect the first language associated with the determined first set of words in real-time. In an instance, the human speaker 116A may be detected as a speaker in English language, whereas the human speaker 116B may be detected as a speaker in French language.

At 406, an operation for a second generative AI model application may be executed. The circuitry 202 may be configured to apply the second generative AI model on the determined first set of words and the detected first language. The second generative AI model may be included in the one or more generative AI models 112. Further, the prediction of the first sentence may be based on the application of the second generative AI model. In an example, the circuitry 202 may predict the sentence spoken by the human speaker 116A as “Hi buddy, how are you?” (in English). The circuitry 202 may further predict the sentence spoken by the human speaker 116B as “Je vais bien”, which is “I am good” (in French).

The electronic device 102 may thereby be able to detect the language of the detected words. It may be possible that within a conversation between two speakers, a first speaker may converse in a first language while a second speaker may converse in a second language. The second ML model may be language agnostic, wherein the second ML model may be able to predict the language of the spoken words. The second generative AI model may be specific to a certain language. For example, there may one version of the second generative AI model for “English” language and another version of the second generative AI model for “French” language. Based on the language detected for a set of spoken words, an appropriate version of the second generative AI model may be selected and applied on the set of spoken words to predict the first sentence in the detected language.

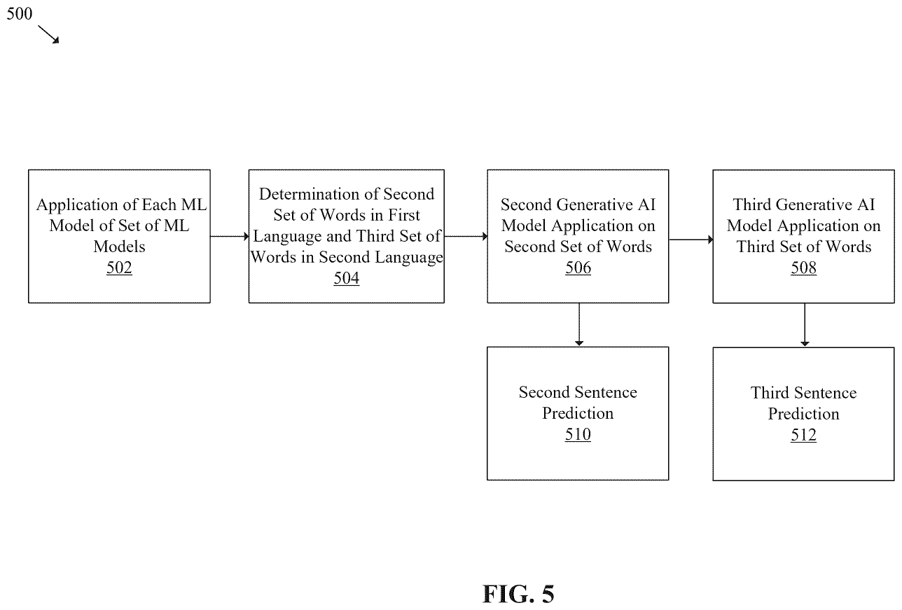

FIG. 5 is a diagram that illustrates a second exemplary processing pipeline for first sentence prediction, in accordance with an embodiment of the disclosure. FIG. 5 is described in conjunction with elements from FIG. 1, FIG. 2, FIG. 3, and FIG. 4. With reference to FIG. 5, there is shown an exemplary second processing pipeline 500 that illustrates exemplary operations from 502 to 512 for implementation of generative AI based visual speech recognition. The exemplary operations 502 to 512 may be executed by any computing system, for example, by the electronic device 102 of FIG. 1 or by the circuitry 202 of FIG. 2.

At 502, an operation for application of a set of ML models may be executed. The circuitry 202 may be configured to apply each ML model of a set of ML models (e.g., the one or more ML models 110) on the determined first set of words spoken by the one or more human speakers 116A and 116B. Each of the set of ML models may represent the first set of words as vectors, through a word embedding process. Each of the set of ML models may efficiently determine a context associated with the determined first set of words, based on a distance metric between vectors of the determined first set of words.

At 504, an operation for determination of a second set of words in a first language and a third set of words in a second language may be executed. The circuitry 202 may be configured to may determine, from the determined first set of words, a second set of words in a first language and a third set of words in a second language, based on the application of each corresponding ML model of the set of ML models. In an embodiment, each ML model of the set of ML models may be trained to detect words in a certain language. For example, an ML model “M1” may be trained to detect a set of words in a first language, such as, “English”. Further, another ML model “M2” may be trained to detect another set of words in a second language, such as, “French”. Thus, based on the application of the ML model “M1” on the first set of words, words that are in the first language (i.e., “English”) may be identified. Similarly, based on the application of the ML model “M2” on the first set of words, words that are in the second language (i.e., “French”) may be identified. Hence, the second set of words in “English” and the third set of words in “French” may be identified by the two ML models “M1” and “M2”, respectively.

At 506, an operation for application of a second generative AI model may be executed. The circuitry 202 may be configured to apply a second generative AI model (e.g., a generative AI model of the one or more generative AI models 112) on the determined second set of words and the first language. For example, the second generative AI model may be a large language model or a natural language processing model trained on the first language and configured to form a meaningful sentence, such as, a second sentence in the first language, based on the determined second set of words. The second generative AI model may break the determined second set of words into multiple tokens, where each of the multiple tokens may be represented as a high-dimensional vector in an embedding space, with respect to the first language associated with the determined second set of words. Embeddings corresponding to each of the multiple tokens may capture semantic relationships between the second set of words, which may allow the second generative AI model to determine a context of the each of the multiple tokens, with respect to the first language.

At 508, an operation for application of a third generative AI model may be executed. The circuitry 202 may be configured to apply a third generative AI model (e.g., a generative AI model of the one or more generative AI models 112) on the determined third set of words and the second language. For example, the third generative AI model may be a large language model or a natural language processing model trained on the second language and configured to form a meaningful sentence, such as, a third sentence in the second language, based on the determined third set of words. The third generative AI model may break the determined third set of words into multiple tokens, where each of the multiple tokens may be represented as a high-dimensional vector in an embedding space, with respect to the second language associated with the determined third set of words. Embeddings corresponding to each of the multiple tokens may capture semantic relationships between the third set of words, which may allow the third generative AI model to determine a context of the each of the multiple tokens, with respect to the second language.

At 510, an operation for a second sentence prediction may be executed. The circuitry 202 may be configured to predict a second sentence in the first language, based on the application of the second generative AI model. In an instance, in case the human speaker 116A speaks in two languages simultaneously, then the circuitry 202 may apply the second generative AI model to the second set of words in the first language, to predict the second sentence (in the first language).

The predicted second sentence may correspond to one of a structured sentence or an unstructured sentence. The second generative AI model may process each of the multiple tokens associated with the second set of words sequentially, and thereby determine the context of each of the multiple tokens based on preceding tokens. Further, the second generative AI model may generate a group of words associated with the preceding tokens based on a prediction of succeeding tokens. The generated group of words may be associated with the determined second set of words. Further, the prediction of the second sentence may be based on the determined second set of words and the generated group of words. In an instance, the determined second set of words may be “I here London”, then the circuitry 202 may predict the second sentence as a structured sentence “I am here in London.” based on the application of the second generative AI model.

At 512, an operation for a third sentence prediction may be executed. The circuitry 202 may be configured to predict a third sentence in the second language, based on the application of the third generative AI model. In an instance, in case the human speaker 116B may speak in two languages simultaneously, then the circuitry 202 may apply the third generative AI model to the third set of words in the second language, to predict the third sentence (in the second language).

The predicted third sentence may correspond to one of a structured sentence or an unstructured sentence. The third generative AI model may process each of the multiple tokens associated with the third set of words sequentially, and thereby determine the context of each of the multiple tokens based on preceding tokens. Further, the third generative AI model may generate a group of words associated with the preceding tokens based on a prediction of succeeding tokens. The generated group of words may be associated with the determined third set of words. Further, the prediction of the third sentence may be based on the determined third set of words and the generated group of words. In an instance, the determined third set of words may be “super” (in the second language), then the circuitry 202 may predict the third sentence as a structured sentence “C′est super” (in the second language, such as, French) based on the application of the third generative AI model.

The prediction of the first sentence may be further based on the prediction of the second sentence and the prediction of the third sentence. For example, in case two speakers speak in different languages, the circuitry 202 may predict each sentence spoken by a speaker in the respective language associated with the speaker. For example, the first sentence may include a second sentence, such as, “How are you?” (in English) and a third sentence, such as, “Je me débrouille bien” (i.e., French for “I am doing well”).

The electronic device 102 may thereby be able to detect the language of the detected words. It may be possible that within a conversation between two speakers, a first speaker may converse in a first language while a second speaker may converse in a second language. By use of ML models associated with specific languages, the electronic device 102 may be able to determine a set of words in one language and another set of words in another language. Thereafter, based on the application of generative AI models associated with specific languages, the set of words determined in each language may be analyzed to predict sentences in each language. Thus, the electronic device 102 of the disclosure may be able to predict multiple sentences in different languages within a same conversation.

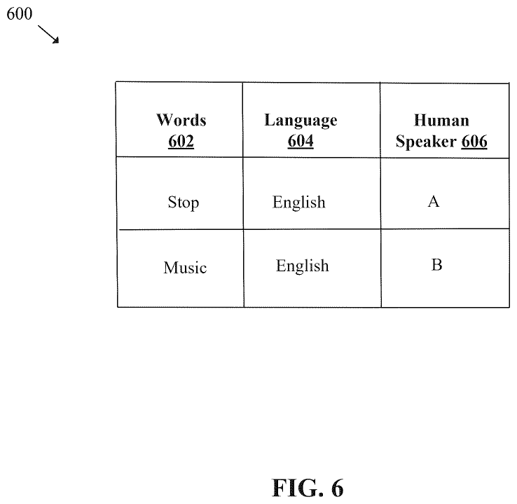

FIG. 6 is a diagram that illustrates an exemplary table including a set of words, in accordance with an embodiment of the disclosure. FIG. 6 is described in conjunction with elements from FIG. 1, FIG. 2, FIG. 3, FIG. 4, and FIG. 5. With reference to FIG. 6, there is shown an exemplary table 600 that illustrates words 602, and corresponding language 604 and human speaker 606.

For instance, the circuitry 202 may determine that the words “stop” and “music” are of the same language (e.g., English). The circuitry 202 may determine that the word “stop” is spoken by the human speaker 116A and the word “music” is spoken by the human speaker 116B. Further, the circuitry 202 may either predict separate sentences for either of the human speaker 116A and the human speaker 116B, or predict a single sentence based on a combination of words spoken by both of the human speaker 116A and the human speaker 116B.

It should be noted that the values in the table 600 of FIG. 6 are for exemplary purposes and should not be construed to limit the scope of the disclosure.

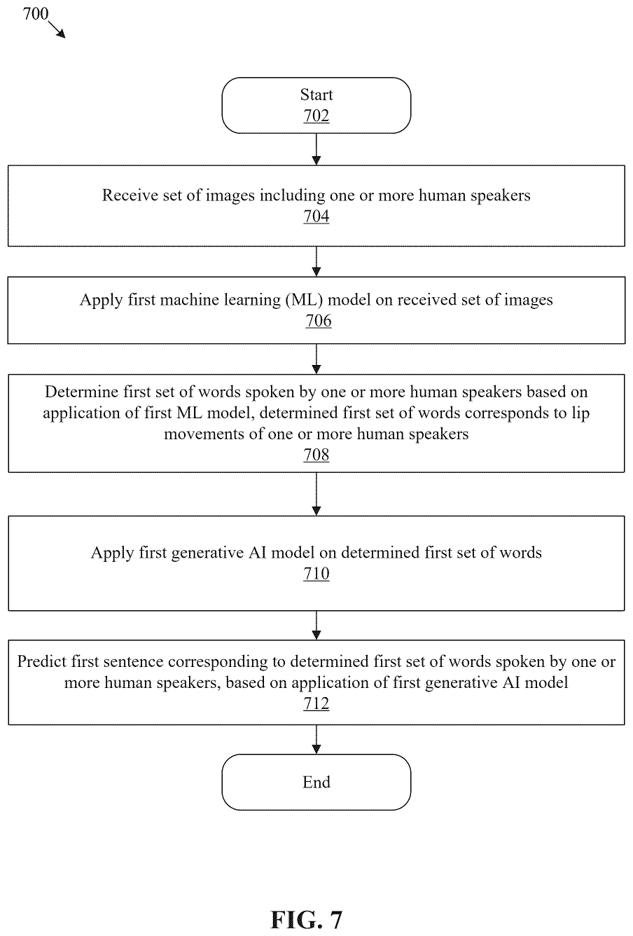

FIG. 7 is a flowchart that illustrates operations of an exemplary method for visual speech recognition based on lip movements, in accordance with an embodiment of the disclosure. FIG. 7 is described in conjunction with elements from FIG. 1, FIG. 2, FIG. 3, FIG. 4, FIG. 5 and FIG. 6. With reference to FIG. 7, there is shown a flowchart 700. The flowchart 700 may include operations from 702 to 712 and may be implemented by the electronic device 102 of FIG. 1 or by the circuitry 202 of FIG. 2. The flowchart 700 may start at 702 and proceed to 704.

At 704, a set of images may be received. The circuitry 202 may be configured to receive the set of images 106B including the one or more human speakers 116A and 116B. The circuitry 202 may extract features of the one or more human speakers from the received set of images. In an example, the extracted features may correspond to lip movements of the human speakers 116A and 116B. Details related to the receipt of the set of images are further described, for example, in FIG. 3 (at 302).

At 706, a first machine learning (ML) model may be applied on the received set of images. The circuitry 202 may be configured to apply the first ML model 110A on the received set of images 106B. In an example, one or more ML models 110, including the first ML model 110A, may process the received set of images 106B based on intensity values of pixels in corresponding set of images 106B. Details related to the application of the first ML model are further described, for example, in FIG. 3 (at 304).

At 708, a first set of words spoken by the one or more human speakers may be determined. The circuitry 202 may be configured to determine the first set of words spoken by the one or more human speakers 116A and 116B based on the application of the first ML model 110A. The determined first set of words may correspond to lip movements of the one or more human speakers 116A and 116B. Details related to the determination of the first set of words spoken by the one or more human speakers are further described, for example, in FIG. 3 (at 306).

At 710, a first generative AI model may be applied on the determined first set of words. The circuitry 202 may be configured to apply the first generative AI model 112A on the determined first set of words. In one or more embodiments, the circuitry 202 may concatenate the determined first set of words, and further apply the first generative AI model 112A on the concatenated first set of words. Details related to the application of the first generative AI model are further described, for example, in FIG. 3 (at 308).

At 712, a first sentence corresponding to the determined first set of words spoken by the one or more human speakers may be predicted, based on the application of the first generative AI model. The circuitry 202 may be configured to predict the first sentence corresponding to the determined first set of words spoken by the one or more human speakers 116A and 116B, based on the application of the first generative AI model 112A. The predicted first sentence may correspond to one of a structured sentence or an unstructured sentence. Details related to the prediction of the first sentence are further described, for example, in FIG. 3 (at 310). Control may pass to end.

Although the flowchart 700 is illustrated as discrete operations, such as, 704, 706, 708, 710, and 712, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the electronic device 102 of FIG. 1). Such instructions may cause the electronic device 102 to perform operations that may include receipt of a set of images (for example, the set of images 106B of FIG. 1) including one or more human speakers. The operations may further include application of a first ML model (for example, the first ML model 110A of FIG. 1) on the received set of images 106B. The operations may further include determination of a first set of words spoken by the one or more human speakers based on the application of the first ML model 110A, the determined first set of words corresponds to lip movements of the one or more human speakers. The operations may further include application of a first generative AI model (for example, the first generative AI model 112A of FIG. 1) on the determined first set of words. The operations may further include prediction of a first sentence corresponding to the determined first set of words spoken by the one or more human speakers, based on the application of the first generative AI model 112A.

Exemplary aspects of the disclosure may provide an electronic device (such as, the electronic device 102 of FIG. 1) that includes circuitry (such as, the circuitry 202 of FIG. 2). The circuitry 202 may be configured to receive a set of images (for example, the set of images 106B of FIG. 1) including one or more human speakers. The circuitry 202 may be configured to apply a first ML model (such as, the first ML model 110A of FIG. 1) on the received set of images 106B. The circuitry 202 may be configured to determine a first set of words spoken by the one or more human speakers based on the application of the first ML model 110A, the determined first set of words corresponds to lip movements of the one or more human speakers. The circuitry 202 may be configured to apply a first generative AI model (such as, the first generative AI model 112A of FIG. 1) on the determined first set of words. The circuitry 202 may be configured to predict a first sentence corresponding to the determined first set of words spoken by the one or more human speakers, based on the application of the first generative AI model 112A.

In an embodiment, the circuitry 202 may be further configured to concatenate the determined first set of words. The circuitry 202 may be further configured to apply the first generative AI model on the concatenated first set of words. The prediction of the first sentence may be further based on the application of the first generative AI model on the concatenated first set of words.

In an embodiment, the predicted first sentence may correspond to one of a structured sentence or an unstructured sentence.

In an embodiment, the circuitry 202 may be further configured to apply a second ML model on the determined first set of words spoken by the one or more human speakers. The circuitry 202 may be further configured to detect a first language associated with the determined first set of words based on the application of the second ML model. The circuitry 202 may be further configured to apply a second generative AI model on the determined first set of words and the detected first language. The prediction of the first sentence may be further based on the application of the second generative AI model.

In an embodiment, the circuitry 202 may be further configured to apply each ML model of a set of ML models on the determined first set of words spoken by the one or more human speakers. The circuitry 202 may be further configured todetermine, from the determined first set of words, a second set of words in a first language and a third set of words in a second language, based on the application of each corresponding ML model of the set of ML models. The circuitry 202 may be further configured to apply a second generative AI model on the determined second set of words and the first language. The circuitry 202 may be further configured to apply a third generative AI model on the determined third set of words and the second language. The circuitry 202 may be further configured to predict a second sentence in the detected first language, based on the application of the second generative AI model. The circuitry 202 may be further configured to predict a third sentence in the second language, based on the application of the third generative AI model. The prediction of the first sentence may be further based on the prediction of the second sentence and the prediction of the third sentence.

In an embodiment, the circuitry 202 may be further configured to receive a set of audio frames associated with the received set of images. The circuitry 202 may be further configured to apply a third ML model on the received set of audio frames. The determination of the first set of words spoken by the one or more human speakers may be further based on the application of the third ML model.

In an embodiment, the circuitry 202 may be further configured to generate a group of words associated with the determined first set of words, based on the application of the first generative AI model 112A. The prediction of the first sentence corresponding to the determined first set of words is further based on the generated group of words.

In an embodiment, the predicted first sentence may include one or more of the generated group of words and the determined first set of words.

In an embodiment, the circuitry 202 may be further configured to detect a first human speaker of the one or more human speakers, based on the received set of images. The determination of the first set of words is further based on the detection of the first human speaker.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
receive a set of images including one or more human speakers;
apply a first machine learning (ML) model on the received set of images;
determine a first set of words spoken by the one or more human speakers based on the application of the first ML model, the determined first set of words corresponds to lip movements of the one or more human speakers;
apply a first generative Artificial Intelligence (AI) model on the determined first set of words; and
predict a first sentence corresponding to the determined first set of words spoken by the one or more human speakers, based on the application of the first generative AI model.

2. The electronic device according to claim 1, wherein the circuitry is further configured to:
concatenate the determined first set of words; and
apply the first generative AI model on the concatenated first set of words, wherein
the prediction of the first sentence is further based on the application of the first generative AI model on the concatenated first set of words.

3. The electronic device according to claim 1, wherein the predicted first sentence corresponds to one of a structured sentence or an unstructured sentence.

4. The electronic device according to claim 1, wherein the circuitry is further configured to:
apply a second ML model on the determined first set of words spoken by the one or more human speakers;
detect a first language associated with the determined first set of words based on the application of the second ML model; and
apply a second generative AI model on the determined first set of words and the detected first language, wherein
the prediction of the first sentence is further based on the application of the second generative AI model.

5. The electronic device according to claim 1, wherein the circuitry is further configured to:
apply each ML model of a set of ML models on the determined first set of words spoken by the one or more human speakers;
determine, from the determined first set of words, a second set of words in a first language and a third set of words in a second language, based on the application of each corresponding ML model of the set of ML models;
apply a second generative AI model on the determined second set of words and the detected first language;
apply a third generative AI model on the determined third set of words and the detected second language;
predict a second sentence in the detected first language, based on the application of the second generative AI model; and
predict a third sentence in the detected second language, based on the application of the third generative AI model, wherein
the prediction of the first sentence is further based on the prediction of the second sentence and the prediction of the third sentence.

6. The electronic device according to claim 1, wherein the circuitry is further configured to:
receive a set of audio frames associated with the received set of images; and
apply a third ML model on the received set of audio frames, wherein
the determination of the first set of words spoken by the one or more human speakers is further based on the application of the third ML model.

7. The electronic device according to claim 1, wherein the circuitry is further configured to:
generate a group of words associated with the determined first set of words, based on the application of the first generative AI model, wherein
the prediction of the first sentence corresponding to the determined first set of words is further based on the generated group of words.

8. The electronic device according to claim 7, wherein the predicted first sentence includes one or more of the generated group of words and the determined first set of words.

9. The electronic device according to claim 1, wherein the circuitry is further configured to:
detect a first human speaker of the one or more human speakers, based on the received set of images, wherein
the determination of the first set of words is further based on the detection of the first human speaker.

10. A method, comprising:
in an electronic device:
receiving a set of images including one or more human speakers;
applying a first machine learning (ML) model on the received set of images;
determining a first set of words spoken by the one or more human speakers based on the application of the first ML model, the determined first set of words corresponds to lip movements of the one or more human speakers;
applying a first generative Artificial Intelligence (AI) model on the determined first set of words; and
predicting a first sentence corresponding to the determined first set of words spoken by the one or more human speakers, based on the application of the first generative AI model.

11. The method according to claim 10, further comprising:
concatenating the determined first set of words; and
applying the first generative AI model on the concatenated first set of words, wherein
the prediction of the first sentence is further based on the application of the first generative AI model on the concatenated first set of words.

12. The method according to claim 10, wherein the predicted first sentence corresponds to one of a structured sentence or an unstructured sentence.

13. The method according to claim 10, further comprising:
applying a second ML model on the determined first set of words spoken by the one or more human speakers;
detecting a first language associated with the determined first set of words based on the application of the second ML model; and
applying a second generative AI model on the determined first set of words and the detected first language, wherein
the prediction of the first sentence is further based on the application of the second generative AI model.

14. The method according to claim 10, further comprising:
applying each ML model of a set of ML models on the determined first set of words spoken by the one or more human speakers;
determining, from the determined first set of words, a second set of words in a first language and a third set of words in a second language, based on the application of each corresponding ML model of the set of ML models;
applying a second generative AI model on the determined second set of words and the detected first language;
applying a third generative AI model on the determined third set of words and the detected second language;
predicting a second sentence in the detected first language, based on the application of the second generative AI model; and
predicting a third sentence in the detected second language, based on the application of the third generative AI model, wherein
the prediction of the first sentence is further based on the prediction of the second sentence and the prediction of the third sentence.

15. The method according to claim 10, further comprising:
receiving a set of audio frames associated with the received set of images; and
applying a third ML model on the received set of audio frames, wherein
the determination of the first set of words spoken by the one or more human speakers is further based on the application of the third ML model.

16. The method according to claim 10, further comprising:
generating a group of words associated with the determined first set of words, based on the application of the first generative AI model, wherein
the prediction of the first sentence corresponding to the determined first set of words is further based on the generated group of words, and
the predicted first sentence includes one or more of the generated group of words and the determined first set of words.

17. A non-transitory computer-readable medium having stored thereon, computer-executable instructions that when executed by an electronic device, causes the electronic device to execute operations, the operations comprising:
receiving a set of images including one or more human speakers;
applying a first machine learning (ML) model on the received set of images;
determining a first set of words spoken by the one or more human speakers based on the application of the first ML model, the determined first set of words corresponds to lip movements of the one or more human speakers;
applying a first generative Artificial Intelligence (AI) model on the determined first set of words; and
predicting a first sentence corresponding to the determined first set of words spoken by the one or more human speakers, based on the application of the first generative AI model.

18. The non-transitory computer-readable medium according to claim 17, wherein the operations further comprise:
generating a group of words associated with the determined first set of words, based on the application of the first generative AI model, wherein
the prediction of the first sentence corresponding to the determined first set of words is further based on the generated group of words, and
the predicted first sentence includes one or more of the generated group of words and the determined first set of words.

19. The non-transitory computer-readable medium according to claim 17, wherein the operations further comprise:
applying a second ML model on the determined first set of words spoken by the one or more human speakers;
detecting a first language associated with the determined first set of words based on the application of the second ML model; and
applying a second generative AI model on the determined first set of words and the detected first language, wherein
the prediction of the first sentence is further based on the application of the second generative AI model.

20. The non-transitory computer-readable medium according to claim 17, wherein the operations further comprise:
applying each ML model of a set of ML models on the determined first set of words spoken by the one or more human speakers;
determining, from the determined first set of words, a second set of words in a first language and a third set of words in a second language, based on the application of each corresponding ML model of the set of ML models;
applying a second generative AI model on the determined second set of words and the detected first language;
applying a third generative AI model on the determined third set of words and the detected second language;
predicting a second sentence in the detected first language, based on the application of the second generative AI model; and
predicting a third sentence in the detected second language, based on the application of the third generative AI model, wherein
the prediction of the first sentence is further based on the prediction of the second sentence and the prediction of the third sentence.
